(19) United States
(12) Patent Application Publication
(10) Pub. No.: US 2008/0067048 A1
(43) Pub. Date: Mar. 20, 2008

(54) ELECTRICAL SWITCHING DEVICE HAVING AT LEAST ONE CONTACT POINT

(75) Inventors: Richard KOMMERT, Heidelberg (DE); Rudiger SCHWEITZER, Neulubheim (DE); Anke DIETZEL, Heidelberg (DE)

Correspondence Address: BUCHANAN, INGERSOLL & ROONEY PC, POST OFFICE BOX 1404, ALEXANDRIA, VA, 22313-1404, US

(73) Assignee: ABB Patent GmbH, Ladenburg (DE)

(21) Appl. No.: 11/857,762

(22) Filed: Sep. 19, 2007

(30) Foreign Application Priority Data
Sep. 20, 2006 (DE) 10 2006 044 055.2

(51) Int. Cl. H01H 1/20; H01H 1/22

(52) U.S. Cl. 200/243; 200/244

(57) ABSTRACT

The disclosure relates to an electrical switching device, in particular a thermal relay having at least one contact point in which, in a first position, the contact point is open and, in a second position, the contact point is closed, having a swivelling contact carrier on which the at least one moving contact piece is held and having an actuator for driving the contact carrier. The actuator is a swivel element, which can rotate about a first axis of rotation, said swivel element being made up of two partial elements, which can be slid in mutually opposing directions and are pushed apart by spring force, of which the first partial element is rotatably mounted and the second partial element acts together with the contact carrier at its free end.

### RELATED APPLICATIONS

This application claims priority under 35 U.S.C. §119 to German Application 10 2006 044 055.2 filed in Germany on Sep. 20, 2006, the entire contents of which are hereby incorporated by reference in their entireties.

### TECHNICAL FIELD

An electrical switching device having at least one contact point is disclosed in which, in a first position, the contact point is open and, in a second position, the contact point is closed, having a swivelling contact carrier on which the at least one moving contact piece is held and having an actuator for driving the contact carrier.

Accordingly, the invention relates to all switches with two switching states, in particular thermal relays, microswitches and auxiliary switches.

### BACKGROUND INFORMATION

In a known thermal overcurrent relay, a thermal bimetal is provided for each phase, the free bent-out ends of which act on a slider by means of which a double-arm lever is actuated, which acts via a further slider on a leaf spring, which is clamped at one end, to the free end of which an arm of a U-shaped snap-action spring is linked, the other arm of which acts on a contact leaf spring. At its free end, the contact leaf spring has a moving contact piece, which, together with a fixed contact piece, forms a contact point. In a first position, the contact point is closed and when the second slider is moved, the leaf spring is bent until the linking point of the snap-action spring reaches its dead point position; when the second slider is moved further, the snap-action spring snaps over and opens the contact point.

Similar arrangements can be found in a large number of variants in other snap-action switch elements.

In these known arrangements, a reduction in the contact force and/or a relative movement in the contact point usually occurs before the contact actually opens. Furthermore, it is usually possible and also necessary to adjust the snap-action device.

### SUMMARY

The object of the disclosure is to create an electrical switching device, in particular a thermal overcurrent relay, in which a slow contact movement is avoided, when actuated by means of the thermal bimetals as well, even at low overcurrents.

According to the disclosure, the actuator is a swivel element, which can rotate about a first axis of rotation, said swivel element being made up of two partial elements, which can be slid in mutually opposing directions and are pushed apart by spring force, of which the first partial element is rotatably mounted and the second partial element acts together with the contact carrier at its free end.

A toggle switch having a contact beam as contact carrier for a moving contact piece has been disclosed in DE 43 24 206 C2. It has a switching piece, which is actuated by a plunger. On the switching piece is a switching roller, which slides on a wedge piece, which, at one end of the contact beam, is fixed to the moving contact piece, which is mounted at its other end in a knife-edge bearing. By actuating the switching piece, the switching roller slides on the wedge piece and in doing so moves the wedge piece out of a first stable position via a dead point position into a second stable position and back again.

A similar arrangement of a switch, in this case a steering column switch, has been disclosed in DE 36 26 241.

Changes in the contact force during the switchover process are not really to be expected with such switching devices as described in DE 43 24 206 or DE 36 26 241. However, switching arrangements as shown in these two publications cannot be used, particularly for thermal relays and the like, as both a normally-closed and a normally-open contact, which must be galvanically isolated from one another, are usually required here. This cannot be realized with known devices according to the prior art, as here the contact beam is galvanically connected to the contact pieces.

At the same time, the two partial elements can be guided telescopically inside one another.

According to a particularly advantageous embodiment of the disclosure, the axis of rotation of the actuator and of the contact carrier can lie on a line, which in a dead point position runs perpendicular to the longitudinal extension of the contact carrier, so that when the actuator is swivelled out of a first stable position via the dead point position in which the actuator is aligned with the line, it is moved into a second stable position and back again.

At the same time, the contact carrier can be constructed as a single-arm or as a double-arm contact carrier.

The mode of operation is then such that, in a switch-on position, for example, the centre axis of the actuator runs at an acute angle to the longitudinal extension of the contact carrier. When the actuator is swivelled, then the tip or free actuating end of the actuator moves into the dead point position in which the longitudinal extension of the actuator is in line with the line connecting the axis of rotation of the contact carrier and of the actuator; as soon as the actuator is swivelled further, this moves into its second stable position in which the at least one contact point is open, wherein the spring between the partial elements relaxes.

This mode of operation comes about when the contact carrier is a single-arm or double-arm lever, on each of the free ends of which at least one contact point is arranged. In this case the one contact point would be closed and the other open, and, when the actuator is swivelled, the other contact point would be closed and the first contact point would be opened.

In a particularly advantageous manner, the at least one contact point is constructed as a double contact point, which has fixed contacts, which can be closed or opened by means of a contact bridge with two moving contact pieces, which is mounted on the contact carrier.

In an advantageous embodiment of the disclosure, the free end of the actuator can be provided with a roller, as a result of which friction forces are reduced.

A further advantageous embodiment of the disclosure can be effected in that a roof-shaped elevation or a roof-shaped projection is provided on the contact carrier so that an exactly defined changeover point is produced here. In doing so, the peak of the elevation lies on the line connecting the pivot point of the actuator and the pivot point of the contact carrier.

Pivot shafts or pivot pins can be provided as axes of rotation; it is, of course, also possible to produce an axis of rotation by providing a knife-edge bearing.

In an advantageous embodiment of the disclosure, the contact carrier is made from electrically non-conducting material, which, if necessary, has a metal plate only on the sliding surface or rolling surface on which the actuator slides during the switching operations.

In a further advantageous embodiment of the disclosure, the contact carrier is made from electrically non-conducting material and is reinforced by means of a metal plate in the area of the knife-edge bearing, which forms the axis of rotation of the contact carrier. This increases the life of the knife-edge bearing.

Further advantageous embodiments and improvements of the disclosure can be seen from the further subclaims.

### BRIEF DESCRIPTION OF THE DRAWINGS

The disclosure, as well as further embodiments and improvements and further advantages, will be explained and described in more detail with reference to the drawing in which some exemplary embodiments of the invention are shown.

FIG. 1 shows a single-arm contact carrier with actuator, and

FIG. 2 to 5 show different embodiments of a double-arm contact carrier in a first switching position in each case.

### DETAILED DESCRIPTION

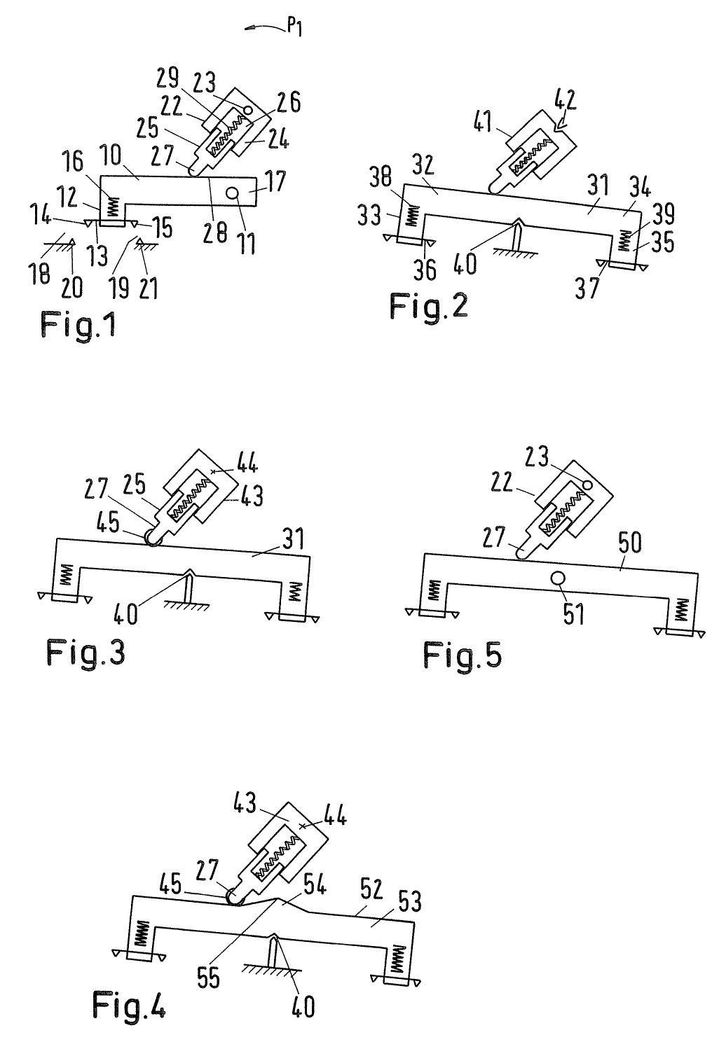

FIG. 1 shows a switching device having a single-arm contact carrier 10, which is rotatably mounted on an axis of rotation 11 in the region of its one end. An L-shaped projection 12 is provided on the other end of the contact carrier 10 in which projection a contact bridge 13 with two moving contact pieces 14 and 15 is mounted, a contact compression spring 16 being provided. The design of the mounting of the contact bridge 13 within the projection 12 is known in itself so that no further comments will be made in this regard.

The contact carrier 10 projects beyond the axis of rotation with an extension 17 in the opposite direction to the projection.

An actuator 22, which is rotatably mounted about an axis of rotation 23, is provided in order to actuate the contact carrier and therefore to open or close the contact points 18 and 19, which are formed by the moving contact pieces 14 and 15 and fixed contact pieces 20, 21. The actuator 22 has a first partial element 24, and the axis of rotation 23 is provided on this first partial element 24. Furthermore, it has a second partial element 25, which engages in an accommodating opening 26 of the first partial element 24; the free end of the second partial element 25 is provided with a pin 27, which slides on the surface 28 of the contact carrier, which is on the opposite side from the contact points. A compression spring 29 is provided between the two partial elements 24 and 25.

The centre axes of the axis of rotation 11 and the axis of rotation 23 lie on a line running perpendicular to the top surface 28.

When the actuator 22 is now swivelled out of the position shown in FIG. 1 in the direction of the arrow P₁, then the free end of the pin 27 slides along the surface 28 or edge 28 of the contact carrier 10, whereby the second partial element 25 slides into the interior of the accommodating opening 26, as a result of which the compression spring 29 is compressed. As soon as the pin 27 slides out over the line connecting the axis of rotation 23 and the axis of rotation 11, the compression spring 29 relaxes and in doing so presses on the extension 17, as a result of which the contact carrier is suddenly swivelled about its axis 11 in the opposite direction to the arrow P₁, i.e. in the clockwise direction.

The length of the extension must then he such that the pin 27 of the actuator also remains in the area of the top surface 28 in the position in which the actuator finds itself after swivelling.

FIG. 2 shows a further embodiment of the disclosure. The contact carrier 31 is constructed as a double-arm carrier, the first arm 32 having an L-shaped extension 33, and the second arm 34 an L-shaped extension 35, so that a U-shape is formed with the two L-shaped moulded-on sections 33 and 35. A contact bridge 36, 37 is mounted on each of the ends of the extensions or projections 33, 35, a contact compression spring 38 and 39 being provided in each case. A knife-edge bearing 40, which is located on the side of the contact carrier opposite to the actuator 41, is provided as an axis of rotation for the contact carrier 31. The actuator 41 and the knife-edge bearing 40 are respectively provided on opposite sides of the contact carrier 31. At the same time, the actuator 41 is also rotatably mounted by means of a knife-edge bearing 42; the mode of operation as such is the same as in the embodiment according to FIG. 1.

In the embodiment according to FIG. 3, the contact carrier 31 is mounted on the knife-edge bearing 40; the actuator 43 is rotatably mounted on an axis of rotation 44, which corresponds to the axis of rotation 23. A roller 45, which rolls on the contact carrier 31, is provided on the free end of the partial element 25, i.e. on the pin 27; the friction force to be applied is reduced in comparison with the embodiments according to FIGS. 1 and 2 in which the pin 27 slides.

The embodiment according to FIG. 5 shows a contact carrier 50, which is constructed in a similar manner to the contact carrier 31; the difference consists only in the fact that the contact carrier 50 is rotatably mounted on a centre pivot shaft 51.

In the embodiment according to FIG. 4, a roof-shaped projection 54, the peak 55 of which is located on the line connecting the axis of rotation 44 of the actuator 43 and the knife-edge bearing 40, is provided on the top side 52 of a contact carrier 53 facing the actuator. In the embodiment according to FIG. 4, the roller 45 is provided at the end of the pin 27; this roller slides on the one side of the roof-shaped extension 54 and, as soon as the roller 45 has passed the roof edge 55, the contact carrier 53 flips over in the clockwise direction so that the contact bridge shown on the left in the drawing is opened and the contact bridge shown on the right in the drawing is suddenly closed.

In the embodiments according to FIGS. 2, 3, 4, the contact carrier 31, 53 in the area of the knife-edge bearing 40, which forms the axis of rotation of the contact carrier 31, 53, can be reinforced by means of a metal plate (not shown). The contact carrier 31, 53 can then also be made from a softer and therefore cheaper plastic material. The wear to be expected in the area of the knife-edge bearing 40 with such materials is counteracted by reinforcing only this small local area by means of a metal plate. The injection of a metal plate into a plastic part is a known manufacturing step which is convenient to carry out.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCES

10 Contact carrier

11 Axis of rotation

12 Projection

13 Contact bridge

14 Moving contact piece

15 Moving contact piece

16 Contact compression spring

17 Extension

18 Contact point

19 Contact point

20 Fixed contact piece

21 Fixed contact piece

22 Actuator

23 Axis of rotation

24 First partial element

25 Second partial element

26 Accommodating opening

27 Pin

28 Contact carrier surface

29 Compression spring

31 Contact carrier as double-arm carrier

32 First arm

33 L-shaped extension

34 Second arm

35 L-shaped extension

36 Contact bridge

37 Contact bridge

38 Contact compression spring

39 Contact compression spring

40 Knife-edge bearing

41 Actuator

42 Actuator knife-edge bearing

43 Actuator

44 Axis of rotation

45 Roller

50 Contact carrier

51 Centre pivot shaft

52 Top side of contact carrier

53 Contact carrier

54 Roof-shaped projection

55 Peak

What is claimed is:

1. Electrical switching device, in particular a thermal relay having at least one contact point in which, in a first position, the contact point is open and, in a second position, the contact point is closed, having a swivelling contact carrier on which the at least one moving contact piece is held and having an actuator for driving the contact carrier, characterized in that the actuator is a swivel element, which can rotate about a first axis of rotation, said swivel element being made up of two partial elements, which can be slid in mutually opposing directions and are pushed apart by spring force, of which the first partial element is rotatably mounted and the second partial element acts together with the contact carrier at its free end.

2. Electrical switching device according to claim 1, wherein the partial elements are guided telescopically inside one another with a spring being inserted between them.

3. Electrical switching device according to claim 1, wherein the axis of rotation of the actuator lies on a line, which in a dead point position runs perpendicular to the longitudinal extension of the contact carrier through its axis of rotation, so that when the actuator is swivelled out of a first stable position via the dead point position in which the longitudinal extension of the actuator lies on this line, it is moved into a second stable position and back again.

4. Electrical switching device according to claim 1, wherein that the contact carrier is a single-arm rotary lever on the free end of which the at least one moving contact piece is arranged.

5. Electrical switching device according to claim 1, wherein the contact carrier is a double-arm lever, which has at least one contact point at each of its free ends.

6. Electrical switching device according to claim 1, wherein a double contact point is provided as the contact point, a contact bridge being arranged on the contact carrier on which moving contact pieces are mounted, which connect together two fixed contact pieces, which are arranged at a distance from one another.

7. Electrical switching device according to claim 1, wherein the axes of rotation of the actuator and/or of the contact carrier have pivot shafts.

8. Switching device according to claim 1, wherein the axes of rotation of the contact carrier and/or of the actuator are formed by knife-edge bearings.

9. Electrical switching device according to claim 1, wherein a pin, which slides on the contact carrier, is provided on the free end of the actuator.

10. Electrical switching device according to claim 1, wherein a roller, which rolls on the contact carrier, is arranged at the free end of the actuator.

11. Electrical switching device according to claim 1, wherein a roof-shaped moulding is arranged on the side of the contact carrier facing the actuator, the peak of which lies on the line connecting the axis of rotation of the contact carrier and the axis of rotation of the actuator.

12. Electrical switching device according to claim 1, wherein the contact carrier is made from electrically insulating material.

13. Electrical switching device according to claim 12, wherein the contact carrier is reinforced by means of a metal plate in the area of the knife-edge bearing, which forms the axis of rotation of the contact carrier.

14. Electrical switching device according claim 1, wherein the area of the contact carrier on which the pin slides or the roller rolls has a reinforcing plate.

15. Electrical switching device according to claim 2, wherein the axis of rotation of the actuator lies on a line, which in a dead point position runs perpendicular to the longitudinal extension of the contact carrier through its axis of rotation, so that when the actuator is swivelled out of a first stable position via the dead point position in which the longitudinal extension of the actuator lies on this line, it is moved into a second stable position and back again.

16. Electrical switching device according to claim 3, wherein that the contact carrier is a single-arm rotary lever on the free end of which the at least one moving contact piece is arranged.

17. Electrical switching device according to claim 4, wherein the contact carrier is a double-arm lever, which has at least one contact point at each of its free ends.

18. Electrical switching device according to claim 5, wherein a double contact point is provided as the contact point, a contact bridge being arranged on the contact carrier on which moving contact pieces are mounted, which connect together two fixed contact pieces, which are arranged at a distance from one another.

19. Electrical switching device according to claim 6, wherein the axes of rotation of the actuator and/or of the contact carrier have pivot shafts.

20. Switching device according to claim 6, wherein the axes of rotation of the contact carrier and/or of the actuator are formed by knife-edge bearings.
